(19) United States
(12) Patent Application Publication
(10) Pub. No.: US 2009/0321603 A1
(43) Pub. Date: Dec. 31, 2009

(54) SUPPORT STRUCTURE FOR CUTTABLE ELEMENTS

(76) Inventor: Rodney A. Krauth, Madison, WI (US)

Correspondence Address: LATHROP & CLARK LLP, 740 REGENT STREET SUITE 400, P.O. BOX 1507, MADISON, WI, 537011507, US

(21) Appl. No.: 11/837,360

(22) Filed: Aug. 10, 2007

(51) Int. Cl. B27B 5/16

(52) U.S. Cl. 248/351

(57) ABSTRACT

A support structure for cuttable members includes side members and feet attached to offset toothed cross members. The toothed cross members are adjustable to support a plurality of cuttable members of different lengths, diameters, and/or sizes. A lower toothed cross member acts as a balance point, with the majority of the cuttable member extending away from the lower toothed cross member side of the support structure. A upper toothed cross member applies a counterbalancing downward force against the cuttable member, securely holding the cuttable member until the center of gravity moves to the upper toothed cross member side of the lower toothed cross member.

### BACKGROUND

1. Field of the Invention

This invention relates to devices and structures for sawing logs and other cuttable members.

2. Related Art

The traditional method for manually cutting logs involves a four-step process. First, the user places a log on the ground. Then, a user saws into the log until a blade of the saw comes close to or into contact with the ground. Next, the user removes the saw from the log. Finally, the user manually rolls the log from 90 degrees to 270 degrees to present a new surface to cut. The user repeats at least steps one through three until the log is cut in two.

Sawbuck structures, which elevate logs and offer stability while a user manually cuts the log, are also known in the art. These structures cradle individual logs in V-shaped members. These designs are described in U.S. Pat. No. 4,121,814 to Prior and U.S. Pat. No. 3,034,546 to Parsons.

Another known structure supports the underside of the log while a user manually cuts multiple logs. This structure, which is described in U.S. Pat. No. 4,678,170 to Sampson, allows the logs to be arranged vertically so the user can cut multiple logs of the same length at the same time.

Additional structures incorporate safety devices and that improve uniformity while cutting logs. For example, U.S. Pat. No. 4,307,640 to Michael attaches a pivot mechanism to a sawbuck. A saw mounts to the pivot mechanism. The saw can then be manually lowered into a log. This structure reduces the danger of injury by minimizing the risk of operator error. This structure also improves accuracy by predetermining and controlling the angle of the saw in relation to the log.

### SUMMARY OF DISCLOSED EMBODIMENTS

While known structures provide an elevated support structure usable for sawing logs, each has limitations. Known structures allow for only limited adjustments based on a number of variables, including the height of the operator or the size of the log. Known structures also require a user to handle the logs a number of times during cutting, especially when making multiple cuts to a single log. These structures are also limited to supporting only rounded logs, not planed wood.

This invention provides a support structure usable for elevating cuttable members off the ground.

This invention further provides a support structure that reduces potential damage to a saw by reducing the chance the saw will make contact with the ground.

This invention separately provides a portable support structure that can be disassembled and reassembled.

This invention separately provides a device usable to adjust a height of the support structure.

This invention further provides a device usable to adjust the support structure based on a diameter of the cuttable member.

This invention separately provides a device that reduces operator handling of the cuttable member.

This invention separately provides a device that supports multiple cuts after one loading step.

This invention separately provides a device that supports both round and planed cuttable members.

This invention separately provides a support structure that can be disassembled, moved and reassembled.

In various exemplary embodiments of a support structure according to this invention, the support structure includes two side members, each connected to a foot. The size and shape of each foot can be varied to stand the support structure by itself or to accept a support beam of varying length, diameter and/or material.

In various exemplary embodiments of the support structure according to this invention, the two side members of the support structure are connected by a plurality of cross members. Two toothed cross members provide both structural support and hold the cuttable member. The two toothed cross members are positioned in an offset configuration. Any additional cross members provide additional support. In various exemplary embodiments, cuttable members are placed between the two toothed cross members. The cuttable member is held in place under its own weight by the offset positioning of the two toothed cross members. In various exemplary embodiments, each of the two toothed cross members can be adjusted, independently of each other, up and down along the two side members to take into account variables including operator height and/or the size, shape and/or dimensions of the cuttable member. In various exemplary embodiments, the upper toothed cross member can be adjusted to form an angle allowing multiple cuttable members of varying dimensions to be placed onto the support structure.

In various exemplary embodiments, the two toothed cross members can each be turned 180 degrees relative to the side members to provide opposing flat holding surfaces. The flat holding surfaces allow planar surfaced cuttable members to be supported by the support structure. In various exemplary embodiments, the cross members can be unfastened from the two side members. The unfastened cross and side members can then be collected and readily transported to a different site for reassembly and use.

These and other features and advantages of various exemplary embodiments of the support structure and methods according to this invention are described in, or are apparent from, the following detailed description of various exemplary embodiments of the article and methods according to this invention.

### BRIEF DESCRIPTION OF DRAWINGS

Various exemplary embodiments of the systems and methods according to this invention will be described in detail, with reference to the following figures, wherein:

FIG. 1 is a perspective view of one exemplary embodiment of a support structure according to this invention;

FIG. 2 is an exploded perspective view of the exemplary embodiment of the support structure shown in FIG. 1;

FIG. 3 is a front plan view of the exemplary embodiment of the support structure shown in FIG. 1; and

FIG. 4 is a side plan view of the exemplary embodiment of the support structure shown in FIG. 1.

### DETAILED DESCRIPTION OF EXEMPLARY EMBODIMENTS

The following is a detailed description of certain exemplary embodiments of a support structure usable to hold or support cuttable members while they are cut according to this invention. For ease of discussion and understanding, the following detailed description refers to cuttable members as logs. It should be appreciated that a cuttable member can be any material, such as, for example, a log, lumber, timber, plastic, metals such as, for example, aluminum or steel, and/or any other known or later developed material that can be suitably used with this device. Likewise, the cuttable members can be any appropriate shape or form, such as random, as when the cuttable member is a log, rectangular, circular, cylindrical, planar, specifically-shaped, such as a turned member like a chair leg, or any other known or later developed shape. It should also be appreciated that the support structure can be used to support members that can be cut, sawed, machined or against which any other known or later-developed work operation, such as, for example, polishing, notching, sanding, welding or planing, can be suitably performed using this device.

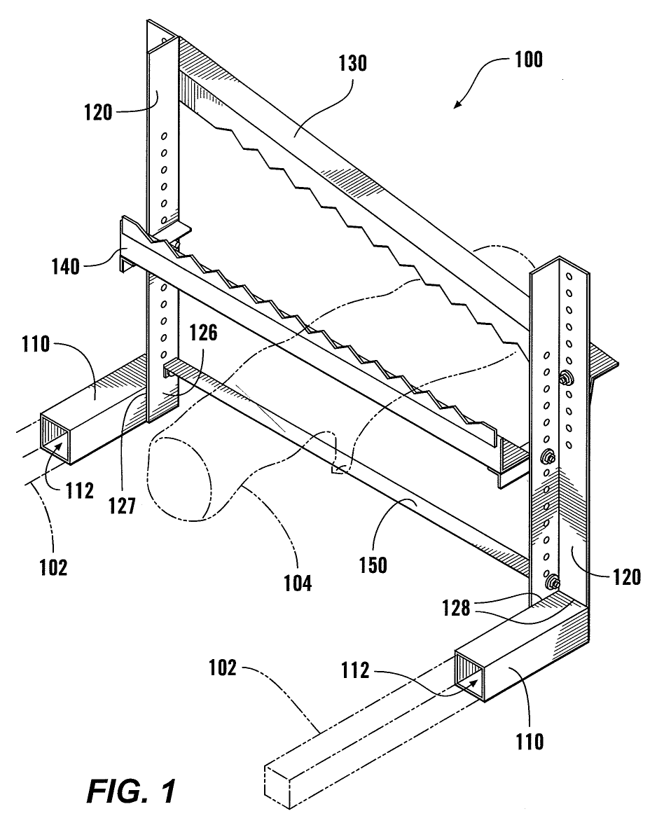

FIG. 1 is a perspective view of one exemplary embodiment of a support structure 100 according to this invention. As shown in FIG. 1, the support structure 100 includes, on each side, a foot 110 attached to a side member 120. An upper toothed cross member 130, a lower toothed cross member 140, and a crossbar 150 are attached between the two side members 120. The upper toothed cross member 130 and lower toothed cross member 140 are offset relative to each other to support a log 104. It should be appreciated that the offset is the horizontal distance between the upper toothed cross member 130 and lower toothed cross member 140 and can be any distance suitable to secure the log 104.

In the exemplary embodiment shown in FIG. 1, to use the support structure 100, a user first adjusts a height and/or an angle of one or both of the toothed cross members 130 and/or 140. The user then inserts a log 104 between the offset upper and lower toothed cross members 130 and 140, as shown in FIG. 1, so that the majority of the log 104 extends from the lower toothed cross member side of the support structure 100. Typically, only a small segment of the log 104 will extend from the upper toothed cross member side of the support structure 100. In this position of the log 104, the lower toothed cross member 140 acts as a balance point. The log 104 thus applies a downward force from its own weight on the lower toothed cross member 140. The upper toothed cross member 130 applies a counterbalancing downward force against the log 104. The support structure 100 securely holds the log 104 as long as the log's 104 center of gravity is on the lower toothed cross member side of the support structure 100.

With the log 104 secured between the upper and lower toothed cross members 130 and 140, the user is able to cut the log 104 one or more times. After cutting the log 104 at least once, the user can either remove the log 104 from the support structure 100 or continue cutting the log 104 down until the log 104 no longer balances because the center of gravity is on the upper toothed cross member side of the lower toothed cross member 140. When the log 104 is no longer able to balance, it automatically disengages from the toothed cross members 130 and 140 and falls out of the support structure 100 to the ground, on the upper toothed cross member side of the support structure 100. It should be appreciated that, in various exemplary embodiments, the user can place a plurality of logs 104 of different lengths, diameters and/or sizes into the support structure 100. It should be appreciated that, in other various exemplary embodiments, the user can use the support structure 100 to hold other types of members beyond cuttable members to perform a variety of tasks, such as, for example, welding, scoring, bending, sanding and/or other operations to other types of members consistent with the above-outlined description.

In the exemplary embodiment shown in FIGS. 1-4, the shape and structure of the foot 110 creates a foundation for the support structure 100 during operation. As shown in FIG. 1, the foot 110 is square and has a passage 112 that is able to accept an extension object 102, such as, in this example, a four by four beam, to improve the stability of the support structure 100. In this exemplary embodiment, each side member 120 has an extension 126 that attaches to the foot 110. Welds attach the extension 126 to the foot 110 along the edge 127 and joints 128.

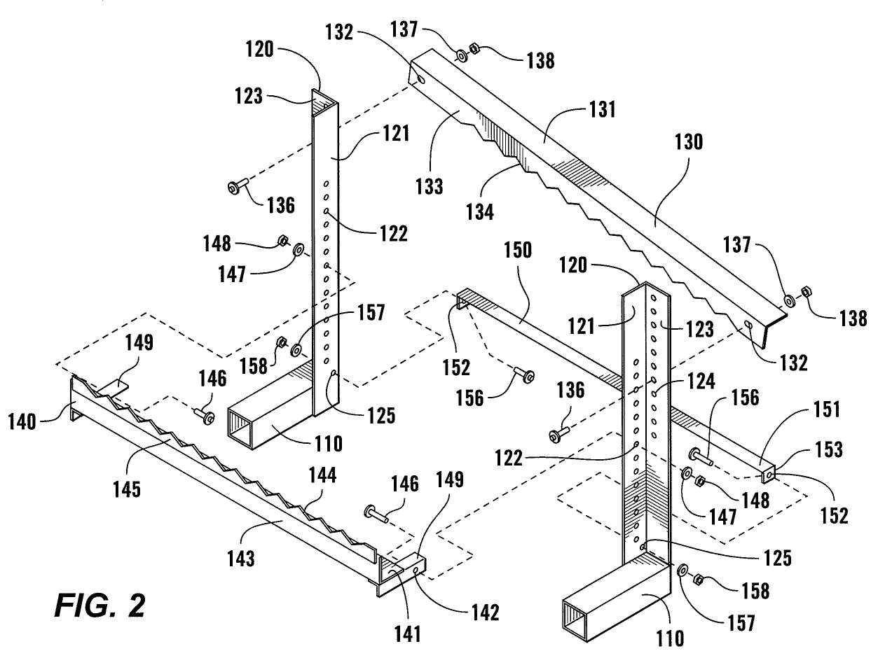

In the exemplary embodiment shown in FIG. 2, the side member 120 includes a first portion 121 and a second portion 123 connected by a weld. As shown in FIGS. 2-4, the first portion 121 and second portion 123 are oriented at a ninety degree angle. Each side member 120 includes mechanisms to connect, disconnect and/or adjust the upper toothed cross member 130, the lower toothed cross member 140 and crossbar 150. In this exemplary embodiment, the mechanism is a plurality of holes 122 on the first portion 121, a plurality of holes 124 on the second portion 123, and a hole 125 on the first portion 121. It should be appreciated that, in other exemplary embodiments, the holes can be any desired size, shape and number.

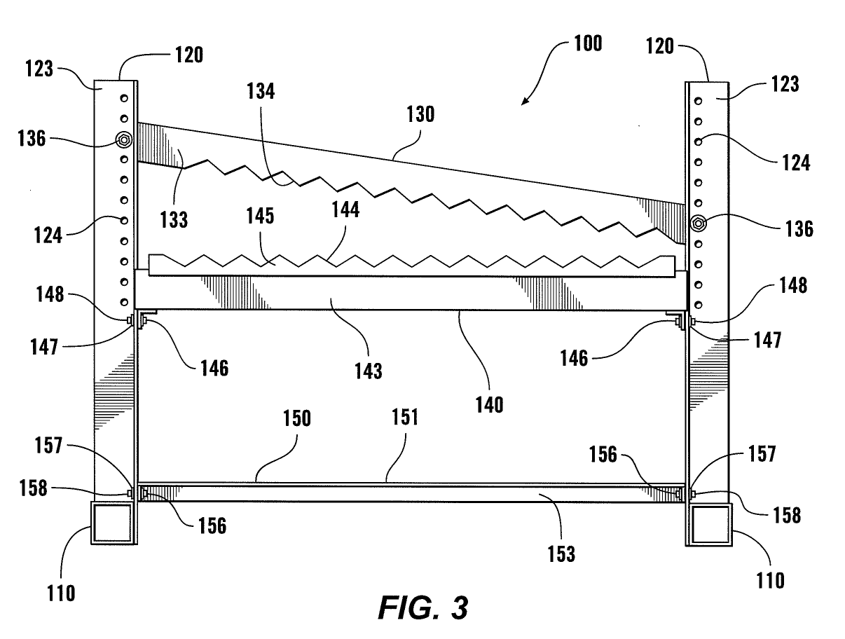

In the exemplary embodiment shown in FIGS. 2-4, the upper toothed cross member 130 includes a first portion 131 and a second portion 133 oriented at a desired angle, such as, for example, ninety degrees. The first portion 131 and second portion 133 of the upper toothed cross member 130 are connected by a weld. As shown in FIGS. 2 and 3, the upper toothed cross member 130 has an integral toothed area 134 designed to engage the log 104. The toothed area 134 of the upper toothed cross member 130 is a series of triangular extensions arranged in a sawtooth orientation.

As shown in FIG. 2, the upper toothed cross member 130 has two oblong holes 132 on the second portion 133. The two oblong holes 132 allow the upper toothed cross member 130 to be adjustably attached to the second portion 123 of the side member 120. The oblong holes 132 are oriented along the upper toothed cross member 130 to allow the upper toothed cross member 130 to be positioned relative to the side members 120 other than horizontally. It should be appreciated that in other exemplary embodiments, the oblong holes 132 can be any desired size, shape, orientation and/or number allowing the upper toothed cross member 130 to be adjusted.

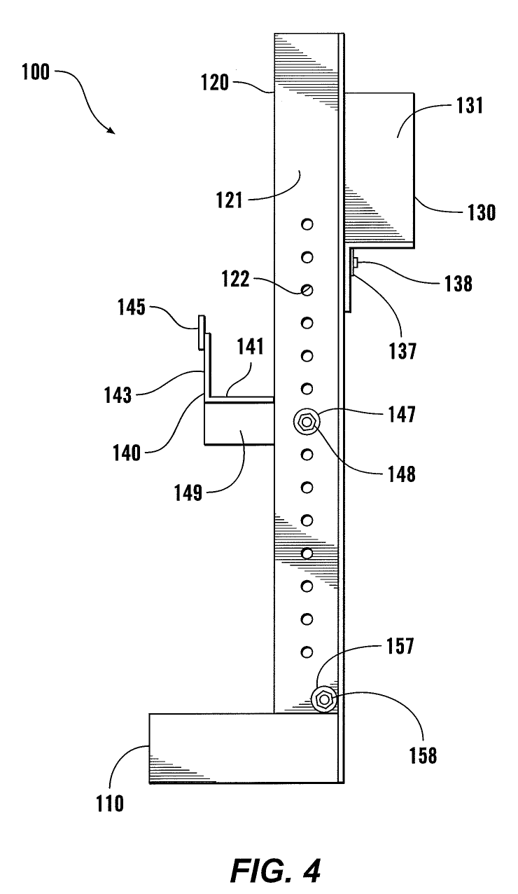

The upper toothed cross member 130 is attached to the second portions 123 of the side members 120 with bolts 136. Each bolt 136 extends first through a hole 124 on the second portion 123, then through the oblong hole 132 of the upper toothed cross member 130. A washer 137 and a nut 138 are then placed on each bolt 136. The bolt 136, washer 137 and nut 138 are removable, allowing the upper toothed cross member 130 to be adjustably attached to both side members 120 through desired holes on the second portions 123. FIGS. 3 and 4 illustrate the angular positioning of the upper toothed cross member 130, and the bolts 136, washers 137 and nuts 138 connecting the upper toothed cross member 130 to the second portions 123 of the side members 120.

In the exemplary embodiment shown in FIGS. 2-4, the lower toothed cross member 140 includes a first portion 141 and a second portion 143 oriented at a desired angle, such as, for example, ninety degrees. A weld connects the first portion 141 and second portion 143 of the lower toothed cross member 140.

As shown in FIGS. 2 and 4, an offset piece 149 is connected to the first portion 141 of the lower toothed cross member 140 by a weld. In FIG. 2, the offset piece 149 has an attachment hole 142 to allow the lower toothed cross member 140 to be adjustably attached to the first portion 121 of the side member 120.

The lower toothed cross member 140 is attached to the first portions 121 of the side members 120 with bolts 146. Each bolt 146 extends first through a hole 142 on the offset piece 149, then through a hole 122 on the first portion 121 of a side member 120. A washer 147 and a nut 148 are then placed on each bolt 146. The bolt 146, washer 147 and nut 148 are removable, allowing the lower toothed cross member 140 to be adjustably attached to the side members 120 through desired holes on the first portions 121. FIGS. 3 and 4 illustrate the positioning of the lower toothed cross member 140, and the bolts 146, washers 147 and nuts 148 connecting the lower toothed cross member 140 to the first portions 121 of the side members 120.

As shown in FIGS. 2 and 3, the lower toothed cross member 140 has a toothed area 144 designed to engage the log 104. In FIGS. 2-4, a separate toothed member 145 forms the toothed area 144 and is attached by welding to the second portion 143 of the lower toothed cross member 140. The toothed area 144 of the lower toothed cross member 140 is a series of triangular extensions arranged in a sawtooth orientation.

In the exemplary embodiment shown in FIGS. 2 and 3, the crossbar 150 includes a first portion 151 and second portions 153 oriented at a desired angle, such as, for example, a ninety degree angle. A bent, continuous piece of material forms the first portion 151 and the second portions 153 of the crossbar 150. As shown in FIG. 2, the crossbar 150 has an attachment hole 152 to allow the crossbar 150 to be adjustably attached to the first portion 121 of the side member 120. The crossbar 150 attaches to the first portions 121 of both side members 120 using bolts 156. Each bolt 156 extends through the attachment hole 152 on the crossbar 150, then through the attachment hole 125 on the first portion 121 of the side member 120. A washer 157 and a nut 158 are then placed on each bolt 156. The bolts 156, washers 157 and nuts 158 are removable, allowing the crossbar 150 to be adjusted and/or removed. FIGS. 3 and 4 show the bolts 156, washers 157 and nuts 158 connecting the crossbar 150 to the first portions 121 of both side members 120.

It should be appreciated that the support structure 100 can be constructed out of any material known or later developed with the strength and rigidity to withstand the operation described above. It should be appreciated that, in other exemplary embodiments, the foot 110 can have other shapes, sizes, lengths and dimensions to accept differently sized and/or shaped extension objects 102. In still other exemplary embodiments, the foot 110 has one or more open sides. In still other exemplary embodiments, the passage 112 has different depths within the foot 110. In still other exemplary embodiments, the foot 110 is solid and of sufficient size, shape and mass to be able to stably support the support structure 100 during operation without the aid of any additional extension objects 102. In still other exemplary embodiments, the foot 110 can be omitted. In such exemplary embodiments, at least one side member 120 is physically connected to a support surface, such as by sinking the side member 120 into the ground, attaching it to another reinforcing structure or supporting it by any other known or later-developed structure that provides sufficient support to withstand operation of the support structure 100.

It should be appreciated that, in other exemplary embodiments, the foot 110 attaches to the side member 110 using a fastener or the like, such as, for example, nuts and bolts, rivets, surface welds and/or any other known or later developed permanent or detachable fastening technology that provides sufficient strength to withstand normal wear and tear when using the support structure 100.

It should be appreciated that, in other exemplary embodiments, the first portion 121 and second portion 123 of the side member 120, the first portion 131 and second portion 133 of the upper toothed cross member 130, the first portion 141 and second portion 143 of the lower toothed cross member 140 and/or the first portion 151 and second portion 153 of the crossbar 150 can be formed and/or connected in different ways. The two portions can be joined by permanent or detachable connections, such as, for example rivets, surface welds, bolting, can be formed by bending a continuous piece of material, by extruding an L-shaped member and/or by any other known or later developed forming or fastening technology that provides sufficient strength to withstand operation of the support structure 100.

It should be appreciated that, in other exemplary embodiments, the side members 120 can have any desired shape and/or orientation that allows a plurality of cross members and cross bars to be adjustably and/or detachably connected to the support structure 100. Some examples include constructing the side members 120 with an integral bend to create an offset, where the side members 120 attach to the feet 110 and bend at an angle at a desired interior location, providing the side members 120 with multiple bends at different angles, or the like. It should be appreciated that, in other exemplary embodiments, the upper toothed cross member 130 and lower toothed cross member 140 can have any desired shape, length and/or orientation that allows either to be adjustably attached to the side members 120 while at the same time able to support the log 104. Some examples include changing the length of offset between cross members, integrating an offset into the upper toothed cross member 130 and/or lower toothed cross member 140, attaching angular pieces to the cross members 130 and/or 140 to create the offset, attaching the offset piece 149 to the upper toothed cross member 130 or changing the length of the cross members 130 and/or 140 to accommodate one or more logs 104. In still other exemplary embodiments, the crossbar 150 can have any shape and/or orientation that allows attachment and/or adjustment of the crossbar 150 to a side member 120.

It should be appreciated that, in other exemplary embodiments, the upper toothed cross member 130, the lower toothed cross member 140 and/or the crossbar 150 can be connected to the side members 120 in different ways. The toothed cross members 130 and/or 140 and/or the crossbar 150 can be connected to the side members 120 using, for example, sliding, interlocking, bolting, pinning, surface welds and/or any other known or later developed permanent or detachable fastening technology that provides sufficient strength to withstand operation of the support structure 100. In still other exemplary embodiments, a plurality of toothed cross members 130 and/or 140 and/or crossbars 150 connect to the first portion 121 and/or the second portion 123 of the side members 120 through various connection mechanisms.

It should be appreciated that, in other exemplary embodiments of the toothed cross members 130 and/or 140, the toothed areas 134 and/or 144 can be implemented as an integral part of that cross member or can be implemented as a separate toothed member. In such exemplary embodiments, the separate toothed member is attached to the second portion of the cross member 133 and/or 143 using, for example, rivets, surface welds, bolts, pins and/or any other known or later developed permanent or detachable fastening technology that provides sufficient strength to withstand operation of the support structure 100.

It should be appreciated that, in other exemplary embodiments of the toothed area 134 and/or 144, the angles between the triangular extensions can be increased and decreased to create different depths. In still other exemplary embodiments, the size of the teeth can be increased or decreased. In still other exemplary embodiments, the teeth have a different shape, such as, for example, one or more of rounded, square, rectangular and/or any other known or later-developed shape usable to engage the log 104 during operation of the support structure 100. In still other exemplary embodiments, a user creates a flat support surface by removing a separate toothed member, rotating the toothed cross members 130 and/or 140 one hundred eighty degrees relative to the side members 120, or not including a toothed area 134 and/or 144 with the toothed cross members 130 and/or 140.

While this invention has been described in conjunction with the exemplary embodiments outlined above, various alternatives, modifications, variations, improvements and/or substantial equivalents, whether known or that are or may be presently foreseen, may become apparent to those having at least ordinary skill in the art. Accordingly, the exemplary embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

1. A support structure, comprising:
a first side member;
a second side member spaced apart from the first side member;
a first support member extending between the first and second side members; and
a second support member extending between the first and second side members and offset along the first and second side members from the first support member;
wherein at least one of the first and second support members is offset from a line connecting the first and second side members.

2. The support structure of claim 1, such that, when a cuttable member is placed between the first and second support members and the center of mass of the cuttable member is on a side of a lower one of the first and second support members facing away from the other one of the first and second support members, the cuttable member is held by the support structure.

3. The support structure of claim 1, further comprising at least one foot, each foot attached to at least one of the first and second side members.

4. The support structure of claim 3, wherein at least one foot is detachable from at least one side member to which it is attached.

5. The support structure of claim 4, wherein at least one foot has a passageway usable to accept an extension object.

6. The support structure of claim 5, wherein at least one of the at least one foot having a passageway has a passageway extending entirely through that foot.

7. The support structure of claim 3, wherein at least one foot has a passageway usable to accept an extension object.

8. The support structure of claim 7, wherein at least one of the at least one foot having a passageway has a passageway extending entirely through that foot.

9. The support structure of claim 1, wherein:
each of the side members has a first portion and a first set of mounting structures arranged along the first portion; and
each end of the first support members has a mounting portion having a mounting structure that is engagable with at least one of the first set of mounting structures.

10. The support structure of claim 9, further comprising fasteners engagable with the mounting structures of the first support members and at least one of the first set of mounting structures of the first portions of the side members to selectively and detachably secure the first support member to the first portions of the side members in a desired orientation.

11. The support structure of claim 1, wherein:
each of the side members has a second portion and a second set of mounting structures arranged along the second portion; and
each end of the second support members has a mounting portion having a mounting structure that is engagable with at least one of the second set of mounting structures.

12. The support structure of claim 11, further comprising fasteners engagable with the mounting structures of the second support members and at least one of the second set of mounting structures of the second portions of the side members to selectively and detachably secure the second support member to the second portions of the side members in a desired orientation.

13. The support structure of claim 1, further comprising at least one crossbar extending between and connectable to the first and second side members.

14. The support structure of claim 1, wherein at least one of the first and second support members has a toothed surface usable to engage a cuttable member.

15. The support structure of claim 14, wherein at least one of the at least one of the first and second support members having a toothed surface has an integral toothed portion.

16. The support structure of claim 14, wherein at least one of the at least one of the first and second support members having a toothed surface has a separate toothed member.

17. The support structure of claim 16, wherein, for at least one of the first and second support members having a separate toothed member, that separate toothed member is detachable from that support member.

18. The support structure of claim 1, wherein at least one of the first and second support members has a flat surface usable to engage a cuttable member when each such support member is mounted to the side members such that the flat surface faces the cuttable member.

19. A method for supporting a member using a support structure having a first support member, and a second support member positioned above the first support member and offset from the first support member, the method comprising:
inserting the member between the first and second support members;
supporting the member on the first support member at a first location along the cuttable member;
allowing the member to rotate about the first support member at the first location until the member engages the second support member at a second location along the member; and
performing a work operation on the member.

20. The method of claim 19, wherein:
the member is a cuttable member; and
performing a work operation on the member comprises cutting the cuttable member.

21. The method of claim 20, wherein cutting the cuttable member comprises cutting the cuttable member into a first portion that is spaced from the first support member; and a remaining portion that is supported by the first support member.

22. The method of claim 21, further comprising, when the cuttable member is cut such that a center of mass of the remaining portion lies on a side of the first support member that faces towards the second support member, automatically disengaging the remaining portion of the cuttable member form the second support member such that the remaining portion falls away from the first support member, such that the support member is ready to accept another cuttable member without operator intervention.

23. The method of claim 22, further comprising, when the cuttable member is cut such that a center of mass of the remaining portion lies on a side of the first support member that faces away from the second support member, repeating the cuttable member cutting step.
